(19) United States
(12) Patent Application Publication
(10) Pub. No.: US 2005/0275610 A1
(43) Pub. Date: Dec. 15, 2005

(54) Liquid crystal display device and driving method for the same

(76) Inventors: Nam-seok Roh, Seongnam-si (KR); Mun-pyo Hong, Seongnam-si (KR); Baek-woon Lee, Yongin-si (KR)

Correspondence Address: CANTOR COLBURN, LLP, 55 GRIFFIN ROAD SOUTH, BLOOMFIELD, CT, 06002, US

(21) Appl. No.: 11/141,420

(22) Filed: May 31, 2005

(30) Foreign Application Priority Data
May 31, 2004 (KR) 10-2004-0039051

(51) Int. Cl. G09G 3/36

(52) U.S. Cl. 345/88

(57) ABSTRACT

Provided are a liquid crystal display (LCD) device and a driving method thereof for displaying high-resolution images. The LCD device comprises a plurality of pixel groups including a first pixel and a second pixel arranged in a same pixel column of two adjacent pixel rows. Each of the first and second pixels forms a dot in combination with an adjacent pixel disposed at each side of the first and second pixels in a corresponding pixel row. A plurality of gate lines arranged for each pixel row in a horizontal direction to transfer a gate voltage to the respective pixels. A plurality of data lines formed in a vertical direction while traversing the gate lines and arranged for each pixel column to transfer a data voltage to the respective pixels. A switching device is formed in each pixel which has a first side and a second side. The switching devices formed at pixels of a first pixel group row are connected to the data lines on the first side, and switching devices formed at pixels of a second pixel group row are connected to the data lines of the second side.

### BACKGROUND OF THE INVENTION

1. Field of the Invention

The present invention relates to an image display device, and more particularly, to a liquid crystal display (LCD) device for displaying high-resolution images and a driving method for the same.

2. Description of the Related Art

In general, an LCD device has a liquid crystal material injected into a space between a color filter substrate on which common electrodes and color filters are formed, and a thin-film transistor (TFT) substrate on which TFT and pixel electrodes are formed. In such an LCD device, images are represented by changing an arrangement of liquid crystal particles by applying different potentials to the pixel electrodes and the common electrodes, thereby controlling the light transmittance of the liquid crystal. Controlling the light transmittance of the liquid crystal allows a control of light passing through the LCD.

There are several types of arrangement of the color filters. Color filters typically include a red (R), a green (G) and a blue (B) color filter formed on the color filter substrate. Examples of types of arrangement of the color filters include a stripe type, a mosaic type and a delta type. In the stripe type arrangement, pixels of the same color are arranged in the same pixel columns. In the mosaic type, the red, green and blue pixels are alternatingly arranged in rows and columns. In the delta type, the pixels are alternatingly arranged zigzag in the columns.

An additional color filter arrangement has been proposed by ClairVoyante Laboratories called a “PenTile Matrix” pixel arrangement. The PenTile Matrix pixel arrangement displays high-resolution images at a minimized design cost. In the PenTile Matrix pixel arrangement, the blue pixel is common to two dots, and neighboring blue pixels receive data signals from one data driving IC while being driven by two different gate driving ICs. By using the PenTile Matrix pixel arrangement, a resolution of the ultra extended graphics array (UXGA) level can be realized using a display device of the super video graphics array (SVGA) level. The PenTile Matrix pixel arrangement also increases the number of low-cost gate driving ICs, but decreases the number of high-cost data driving ICs. Thus, the production cost for a display device using the PenTile Matrix pixel arrangement is minimized. In order to realize high-resolution images, an LCD device having the PenTile Matrix pixel arrangement employs a rendering driving method.

To prevent the deterioration of the liquid crystal, the LCD device having the PenTile Matrix pixel arrangement performs an inversion of a data voltage at a predetermined interval. Examples of a method of inverting the data voltage include a vertical inversion driving method and a dot inversion driving method. The vertical inversion driving method includes inverting polarities of the data voltage for predetermined columns. The dot inversion driving method includes inverting the polarities of the data voltage by pixel.

The vertical inversion driving method may reduce a switching stress or a signal delay in data lines, because the method inverts the polarities of the data voltage, which flows through one data line. However, the vertical inversion driving method causes a vertical flicker phenomenon and vertical crosstalk.

The dot inversion driving method may prevent the problems of the vertical flicker phenomenon and the vertical crosstalk. However, since the dot inversion driving method must invert the polarities of the data voltage for the predetermined column and row, the operation of applying the data voltage to data lines is complicated and results in a serious problem of signal delay in the data lines. Accordingly, the data lines are made of a low resistance material to reduce the signal delay, increasing the complexity and cost of manufacturing.

Furthermore, in the case where the polarities of red pixels, green pixels, and blue pixels are irregular when performing the inversion on the LCD device having the PenTile Matrix pixel arrangement, the flicker phenomenon occurs and a luminance difference is generated between pixel columns, resulting in a deteriorated display quality of the LCD device.

Accordingly, there is a demand for an improved driving method for the LCD device having the PenTile Matrix pixel arrangement which utilizes the rendering driving method and realizes excellent image quality by uniformly inverting the polarities of color pixels, and minimizing a driving constraint.

### SUMMARY OF THE INVENTION

The present invention provides a liquid crystal display (LCD) device, which can easily employ a rendering driving method of displaying high-resolution images. The present invention also provides an LCD device, which can perform a two-dot inversion with an excellent display characteristic and can perform a regular inversion driving of green, blue, and red pixels. Further, the present invention provides an LCD device with improved luminance.

The present invention also provides a driving method of an LCD device, which can minimize a driving constraint by inverting the polarity of a data voltage flowing through one data line by frame and can perform a two-dot inversion for an apparent pixel inversion. In addition, the present invention provides a driving method of an LCD device, which can minimize the driving constraint by inverting the polarity of the data voltage flowing through one data line and can prevent a vertical flicker phenomenon and vertical crosstalk.

According to an aspect of the present invention, there is provided an image display device comprising a plurality of pixel groups including a first pixel and a second pixel arranged in a same pixel column of two adjacent pixel rows. Each of the first and second pixels forms a dot in combination with an adjacent pixel disposed at each side of the first and second pixels in a corresponding pixel row. A plurality of gate lines is arranged for each pixel row in a horizontal direction to transfer a gate voltage to the respective pixels. A plurality of data lines is formed in a vertical direction while traversing the gate lines and arranged for each pixel column to transfer a data voltage to the respective pixels. A switching device is formed in each pixel which has a first side and a second side. The switching devices formed at pixels of a first pixel group row are connected to the data lines of the first side, and switching devices formed at pixels of a second pixel group row are connected to the data lines on the second side. The LCD device may be driven by a rendering operation method.

In another aspect of the present invention, the first and second pixels of the pixel group are a blue pixel and a white pixel, respectively, the pixels located at the left side are red and green pixels, the pixels located at the right side are green and red pixels, and the pixels of a same color face each other diagonally from the perspective of the first and second pixels.

In this embodiment, the blue and white pixels of one pixel group have a first polarity, the red and green pixels have a second polarity, and the first and second polarities are inverted in pixel groups that are adjacent to each other. In addition, the locations of the blue pixel and the white pixel are alternately shifted in pixel groups that are adjacent to each other in a row direction.

According to another aspect of the present invention, there is provided a method of driving an image display device having gate lines, data lines, and pixels associated with the gate and data lines. The driving method includes sequentially providing gate voltages to the gate lines of the image display device, and providing data voltages having a first polarity to the data lines of first and second pixels in a first pixel group and providing data voltages having a second polarity to the data lines of pixels surrounding the first and second pixels in the first pixel group.

In this embodiment, the data voltages applied to the data lines may be column inversion driving signals or vertical inversion driving signals.

This application claims the priority of Korean Patent Application No. 10-2004-0039051 filed on May 31, 2004, in the Korean Intellectual Property Office, the disclosure of which is incorporated herein in its entirety by reference.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram illustrating an arrangement of pixels and switching devices in a liquid crystal display (LCD) device according to a first embodiment of the present invention;

FIG. 2 illustrates an arrangement of pixels and a thin-film transistor (TFT) substrate of the LCD device according to the first embodiment of the present invention;

FIG. 3 is a sectional view illustrating the TFT substrate of the LCD device cut along the line III-III′ of FIG. 2;

FIG. 4 is a block diagram illustrating a driving device of driving the LCD device according to the first embodiment of the present invention;

FIG. 5 illustrates polarities applied to pixels when performing a vertical inversion driving on the LCD device according to the first embodiment of the present invention;

FIG. 6 is a schematic diagram illustrating an arrangement of pixels and switching devices in an LCD device according to a second embodiment of the present invention;

FIG. 7 illustrates the arrangement of pixels and a TFT substrate of the LCD device according to the second embodiment of the present invention;

FIG. 8 is a schematic diagram illustrating an arrangement of pixels and switching devices in an LCD device according to a third embodiment of the present invention;

FIG. 9 illustrates the arrangement of pixels and a TFT substrate of the LCD device according to the third embodiment of the present invention; and

FIG. 10 illustrates an arrangement of pixels and a TFT substrate of an LCD device according to a fourth embodiment of the present invention.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

A liquid crystal display (LCD) device and a method of driving the same according to a first embodiment of the present invention will now be described.

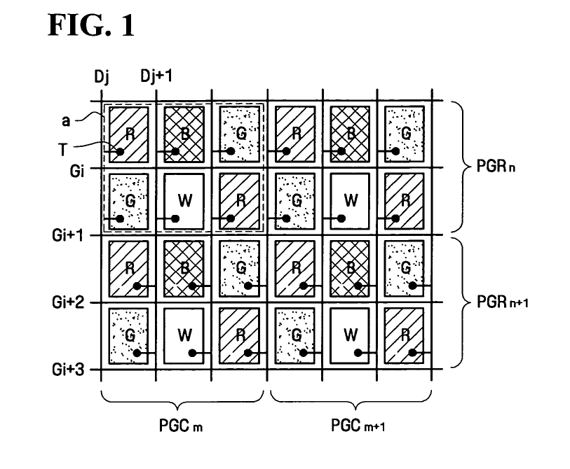

FIG. 1 is a schematic diagram illustrating an arrangement of pixels and switching devices in an LCD device according to the first embodiment of the present invention.

Referring to FIG. 1, the LCD according to the first embodiment of the present invention includes color filters of red pixels R, blue pixels B, green pixels G, and white pixels W, arranged in a matrix pattern. The red pixel R of the first row is arranged in the same column as the green pixel G of the second row, the blue pixel B of the first row is arranged in the same column as the white pixel W of the second row, and the green pixel G of the first row is arranged in the same column as the red pixel R of the second row. Thus, the red pixels R of the first and second rows face each other diagonally from opposite sides of the blue pixel B and the white pixel W. Similarly, the green pixels G of the first and second rows face each other diagonally from opposite sides of the blue pixel B and the white pixel W.

The blue pixel B and the white pixel W arranged in the same column and two adjacent rows are defined as a first pixel B and a second pixel W. The first and second pixels B and W form a group together with the adjacent red and green pixels R and G arranged at opposite sides of the first and second pixels B and W. The group is referred to as a pixel group a. The pixel group a forms at least two dots. The pixel group a is repeatedly formed in a row direction and in a column direction, thereby forming a pixel group row PGR and a pixel group column PGC.

Since the first and second pixels B and W can represent at least two dots together with peripheral pixels, the LCD device according to the first embodiment of the present invention can provide for improved rendering, thereby displaying high-resolution images. Meanwhile, the use of white pixels reduces the number of color pixels, and improves the luminance of the LCD device.

Gate lines G for transferring gate voltages are formed horizontally one by one for each pixel row. Data lines D for transferring data voltages and traversing the gate lines G to define unit pixels are formed vertically for each pixel column in a manner such that they are insulated from the gate lines G. In this embodiment, thin film transistors (TFTs) used as switching devices are formed at an intersection of the gate lines G and the data lines D of the respective pixels. A left side and a right side of each pixel relative to a direction parallel to the data line D are defined as a first side and a second side, respectively. The TFTs T of the pixels in a pixel group row PGRₙ are electrically connected to the data lines on the first side of each pixel, for example, Dj, and the TFTs T of the pixels of an adjacent pixel group row PGRₙ₊₁ are electrically connected to the data lines on the second side of each pixel, for example, Dj+1. Thus, the TFTs of the pixels included in rows i and i+1 are connected to the data lines at the left side of the pixels, and the TFTs of the pixels included in the rows i+2 and i+3 are connected to the data lines at the right side of the pixels, as shown in FIG. 1. In other words, the locations of the TFTs are alternately formed by pixel group row PGR.

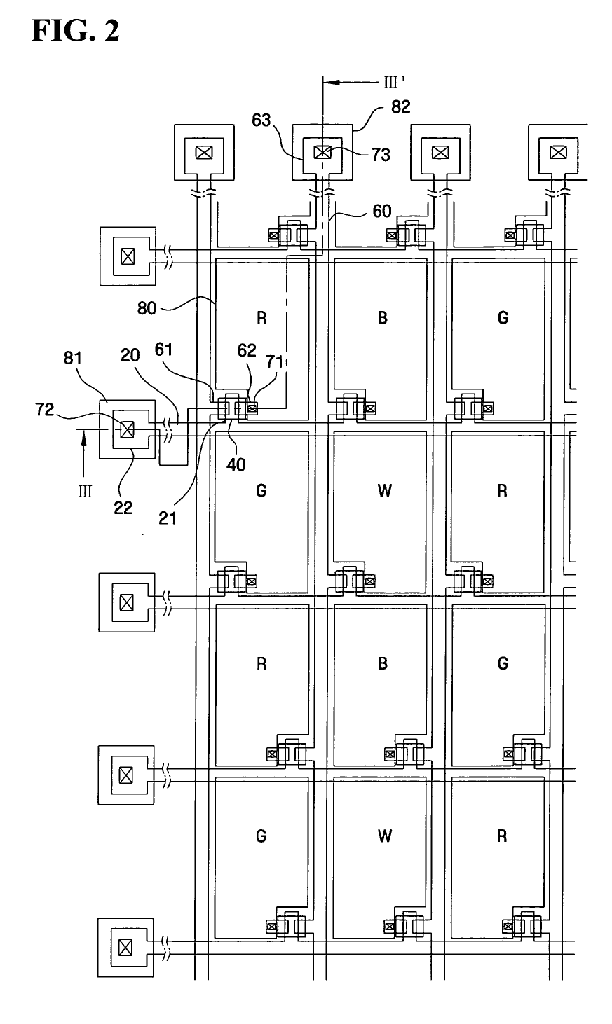

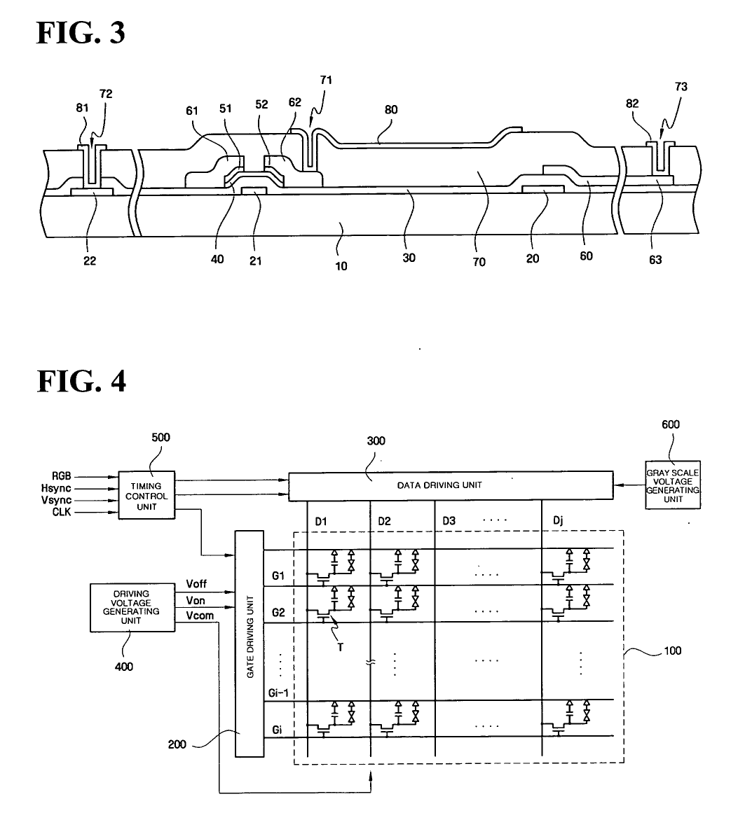

Next, a structure of a TFT substrate of the LCD device according to the first embodiment of the present invention will be described in greater detail with reference to FIGS. 2 and 3.

FIG. 2 illustrates the arrangement of pixels and the TFT substrate of the LCD device according to the first embodiment of the present invention. FIG. 3 is a sectional view illustrating the TFT substrate of the LCD device of FIG. 2 cut along line III-III′.

As shown in FIGS. 2 and 3, a gate wire is formed on an insulating substrate 10. The gate wire includes a gate line 20, which is formed for each pixel row in a pixel row direction, a gate pad 22, which is connected to the end of the gate line 20 to transfer gate signals from an external source to the gate line 20, and a gate electrode 21 of the TFT connected to the gate line 20. In addition, a gate insulating layer 30 made of an insulating material, such as silicon nitride or silicon oxide, is formed on the insulating substrate 10, covering the gate wire. A semiconductor layer 40 made of a semiconductor material, e.g., amorphous silicon, is formed over a portion of the gate insulating layer 30 on the gate electrode 21. Resistant contact layers 51 and 52 made of silicide or n+ amorphous silicon hydride with which n-type impurity is highly doped are formed on the semiconductor layer 40.

A data wire is formed on the resistant contact layers 51 and 52 and the gate insulating layer 30. The data wire includes a data line 60, which traverses the gate line 20 to define each pixel, a source electrode 61, which is a basin of the data line 60 and extends to the upper portions of the resistant contact layers 51 and 52, a data pad 63, which is connected to one end of the data line 60 and receives image signals from an external source, and a drain electrode 62. The drain electrode 62 is separated from the source electrode 61 and is formed on the resistant contact layer 52 in a position opposite to the source electrode 61 from the perspective of the gate electrode 21.

The TFT includes the gate electrode 21 connected to the gate line 20, the source electrode 61 connected to the data line 60, the drain electrode 62 formed opposite to the source electrode 61 from the perspective of the gate electrode 21, and the semiconductor layer 40. In addition, the left and right sides of each pixel relative to the direction parallel to the data line 60 are defined as a first side and a second side, respectively. The source electrodes 61 of the TFTs in the pixels included in a pixel group row PGRₙ are electrically connected to the data lines on the first side of each pixel. The source electrodes 61 of the TFTs in the pixels included in the adjacent pixel group row PGRₙ₊₁ are electrically connected to the data lines on the second side. Thus, the TFTs of the pixels included in rows i and i+1 are connected to the data lines at the left side of each pixel, and the TFTs of the pixels included in the rows i+2 and i+3 are connected to the data lines at the right side of each pixel, as shown in FIG. 2. In other words, the locations of the TFTs are alternately formed by pixel group row PGR. The left and right sides of each pixel are opposite to each other with respect to a vertical center line (imaginary line) of each pixel.

A protective layer 70 is formed on the data wire and the exposed portion of the semiconductor layer 40. The protective layer 70 includes contact holes 71 and 73, which expose the drain electrode 62 and the data pad 63, respectively, and a contact hole 72, which exposes the gate insulating layer 30 and the gate pad 22.

A pixel electrode 80 electrically connected to the drain electrode 62 through the contact hole 71 is formed on the protective layer 70. In addition, an auxiliary gate pad 81 and an auxiliary data pad 82 connected to the gate pad 22 and the data pad 63 through the contact holes 72 and 73, respectively, are formed on the protective layer 70. Here, the pixel electrode 80 overlaps the gate line 20, forming a sustain capacitance. Although the sustain capacitance is formed by overlapping the pixel electrode 80 on the gate line 20 in this embodiment of the present invention, the sustain capacitance may also be designed by separate wiring.

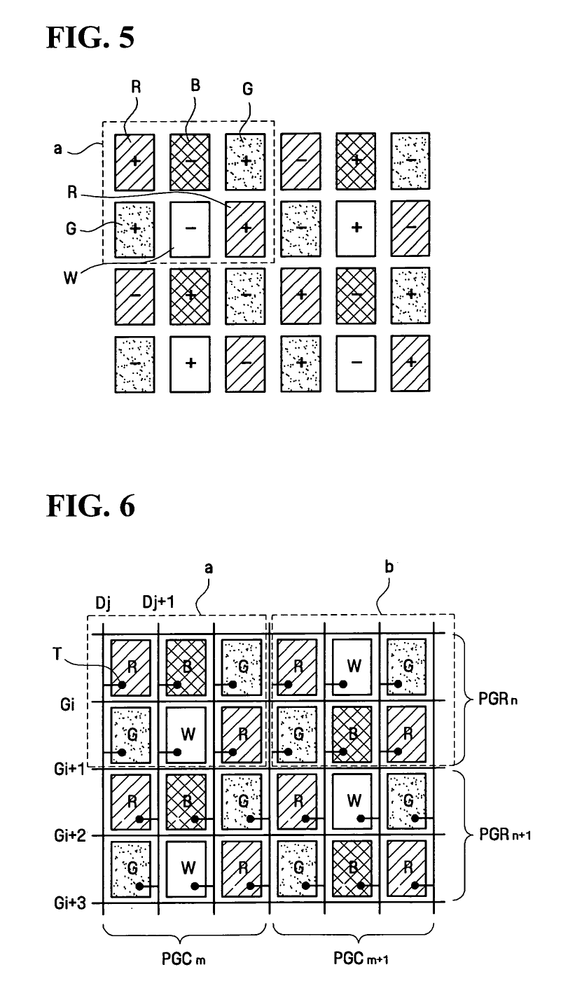

A device and a method of driving an LCD device according to the first embodiment of the present invention will now be described in greater detail with reference to FIGS. 4 and 5.

FIG. 4 is a block diagram illustrating a driving device for driving the LCD device according to the first embodiment of the present invention, and FIG. 5 illustrates polarities applied to pixels when performing a vertical inversion driving on the LCD device according to the first embodiment of the present invention.

As shown in FIG. 4, the driving device of the LCD device according to the first embodiment of the present invention has a gate driving unit 200, a data driving unit 300, a driving voltage generating unit 400, a timing control unit 500, and a gray scale voltage generating unit 600.

The timing control unit 500 receives red, green, and blue data signals (RGB), vertical synchronization signals (Vsync) as frame discrimination signals, horizontal synchronization signals (Hsync) as row discrimination signals, and main clock signals (CLK) from a graphic controller (not shown) outside of the driving device. The timing control unit 500 outputs various digital signals for driving the gate driving unit 200 and the data driving unit 300. More specifically, the timing control unit 500 outputs reverse signals (RVS) for inversion driving to the data driving unit 300.

The data driving unit 300 shifts voltage values transferred to each pixel in a liquid crystal panel 100 down by one line. More specifically, the data driving unit 300 stores digital image data from the timing control unit 500 in a shift register. The data driving unit 300 then selects a voltage corresponding to each digital image data when receiving a signal commanding a shift of the data to the liquid crystal panel 100. The data driving unit 300 transfers the voltage to the liquid crystal panel 100 upon receiving the signal commanding the shift. The polarities of the data voltages are inverted based on the inversion control signals from the timing control unit 500 and the inverted polarities are provided to the liquid crystal panel 100.

The gate driving unit 200 activates a switch allowing data from the data driving unit 300 to be transferred to the pixels. The pixels of the liquid crystal panel 100 are turned on/off by the TFT T serving as the switch by applying predetermined voltages Von and Voff to the gate of the TFT T.

The predetermined voltages Von and Voff are generated in the driving voltage generating unit 400. The driving voltage generating unit 400 generates a Vcom voltage as a reference of a data voltage difference between the TFT T and the predetermined voltages Von and Voff. Additionally, the gray scale voltage generating unit 600 generates a gray scale voltage input to the data driving unit 300.

Now, a method of driving the LCD device according to the first embodiment of the present invention will be described.

The timing control unit 500 receives image signals to be applied to the liquid crystal panel 100 from an external signal source (not shown). The timing control unit 500 processes the image signals to output to the data driving unit 300. The timing control unit 500 also generates various timing signals for driving the liquid crystal panel 100. The gate driving unit 200 sequentially outputs gate voltages to the gate lines G1 through Gi. The gate voltages turn on the TFTs T of each pixel allowing each pixel to receive data voltage. Then, the data driving unit 300 applies the data voltages, including the gray scale voltages, transferred from the timing control unit 500 to data lines D1 through Dj, which are formed in the liquid crystal panel 100. Accordingly, the gate voltages are sequentially applied to gate lines G1 through Gi, and the data voltages are transferred to the pixels when appropriate.

In the present embodiment, the data driving unit 300 inverts the polarities of the data voltages according to odd data lines D1, D3, etc., and even data lines D2, D4, etc., based on the inverse control signals from the timing control unit 500, and inverts the polarities of the data voltages to the data lines according to frame. More specifically, the data voltages flowing through the odd data lines D1, D3, etc., have a first polarity, and the data voltages flowing through the even data lines D2, D4, etc., have a second polarity, which is opposite to the first polarity. Additionally, the data voltage of the first polarity or the second polarity flowing through each data line is inverted according to the frame.

A method such as that described above is referred to as a column inversion driving method or a vertical inversion driving method. The vertical inversion driving method can minimize driving constraints, such as switching stress, degradation, and signal delay, by inverting the data voltages according to the frame.

When driving the LCD device according to the first embodiment of the present invention by the vertical inversion driving method, the data voltage applied to each pixel is alternately inverted by two dot groupings, referred to as a two-dot inversion. In other words, pixels of two vertically adjacent dots forming a first group have opposite polarities to each corresponding pixel of vertically and horizontally adjacent groups of two dots forming a second group, a third group, etc. Such a dot inversion between pixels can prevent a vertical flicker phenomenon and vertical crosstalk, thereby allowing the LCD to display excellent images.

Thus, when the blue pixel B and the white pixel W of the pixel group a are negative, the red pixels R and the green pixels G are positive, as shown in FIG. 5. In addition, the polarities of the pixels of the pixel group a are inverted for pixel groups adjacent to the pixel group a in the row direction PGR and in the column direction PGC, respectively.

The green pixels G, the blue pixels B, the red pixels R, and the white pixels W are regularly inverted each subsequent frame, so that the polarities of the colors in each pixel group are distributed as described above. Accordingly, the flicker phenomenon due to a difference in the transmittance between colors can be prevented.

Next, an LCD and a driving method thereof according to a second embodiment of the present invention will be described in greater detail.

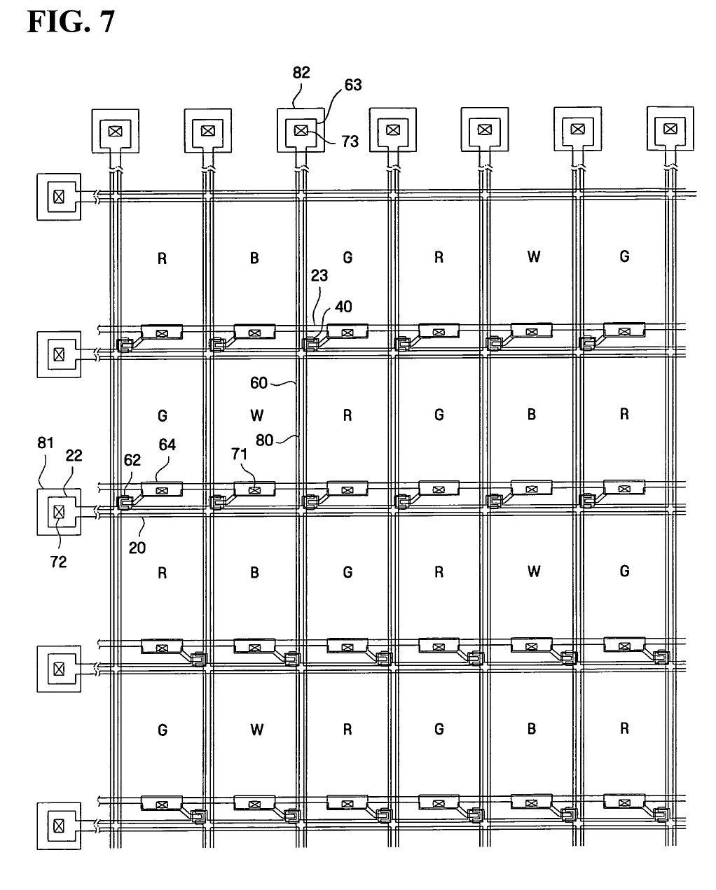

FIG. 6 is a schematic diagram illustrating an arrangement of pixels and switching devices in the LCD device according to the second embodiment of the present invention, and FIG. 7 illustrates the arrangement of pixels and a TFT substrate of the LCD device according to the second embodiment of the present invention.

As shown in FIGS. 6 and 7, most structure of the LCD device according to the second embodiment of the present invention is the same as that of the LCD device according to the first embodiment of the present invention, except for the arrangement of the pixels and some portions of the structure.

In the LCD device according to the second embodiment of the present invention, red pixels R, blue pixels B, green pixels G, and white pixels W are arranged in a matrix pattern. The matrix pattern includes, a red pixel R, a blue pixel B, a green pixel G, a red pixel R, a white pixel W, and a green pixel G sequentially arranged on a first row, and a green pixel G, a white pixel W, a red pixel R, a green pixel G, a blue pixel B, and a red pixel R sequentially arranged on a second row. Accordingly, a first pixel group a and a second pixel group b are formed around the blue pixel B and the white pixel W of each pixel group. The blue and white pixels B and W are arranged in adjacent pixel rows and the same pixel column. Red and green pixels R and G are disposed on opposite sides of each of the blue and white pixels B and W such that each red pixel R of the first row is in the same column as each green pixel G of the second row and each green pixel G of the first row is in the same column as each red pixel R of the second row.

In the present embodiment, the first and second pixel groups a and b are alternately repeated in a column direction to form a pixel group row. In addition, the first and second pixel groups a and b are sequentially arranged in a row direction to form each pixel group column. As a result, the blue pixels B, the red pixels R, and the green pixels G are zigzagged over two adjacent pixel rows, and the white pixels W are also zigzagged.

A structure of a TFT substrate of the LCD device according to the second embodiment of the present invention will now be described with reference to FIG. 7. The structure of the TFT substrate is similar to that of the TFT substrate according to the first embodiment of the present invention, thus a detailed explanation of the same parts will not be given.

In the LCD device according to the second embodiment of the present invention, a sustain electrode line 23, which forms a sustain capacitance by overlapping a pixel electrode 80, is formed on the same layer as a gate line 20 in a horizontal direction. In addition, a data wire is connected to a drain electrode 62. The data wire further includes a conductor pattern 64 for the sustain capacitance. The conductor pattern 64 overlaps the sustain electrode line 23 to increase the sustain capacitance. The sustain capacitance may be formed by overlapping the pixel electrode with the gate line, as was done in the first embodiment of the present invention.

In addition, the contact hole 71 of the protective layer 70 of FIG. 3 used to connect the pixel electrode 80 to the data wire is formed on the conductor pattern 64 to create the sustain capacitance. Thin film transistors (TFTs) formed in the pixels included in the rows i and i+1 are connected to the data lines at the left side, and thin film transistors formed in the pixels included in the rows i+2 and i+3 are connected to the data lines at the right side. In other words, the locations of the TFTs are alternately shifted by pixel group row.

Furthermore, since the blue pixels B and the white pixels W are zigzagged, as well as the red pixels R and the green pixels G, vertical patterns due to specific pixels, for example, the blue pixels B are not recognized. Thus, the LCD device according to the second embodiment of the present invention can display images of better quality than the LCD device according to the first embodiment of the present invention.

An LCD device and a driving method thereof according to a third embodiment of the present invention will now be described.

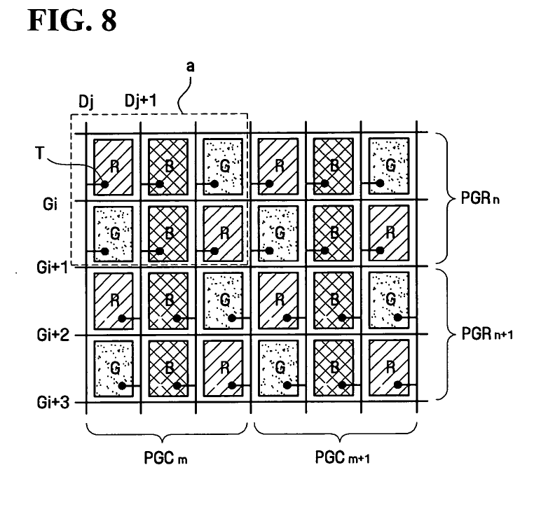

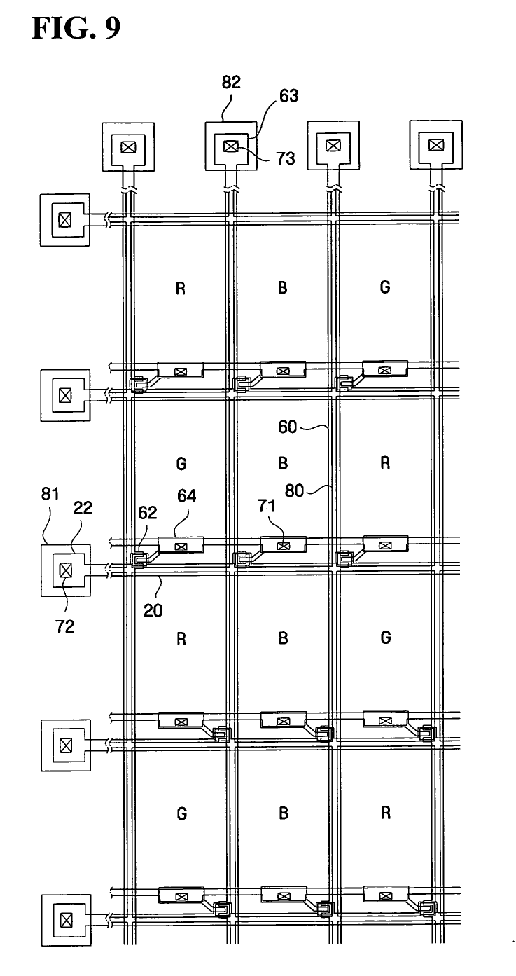

FIG. 8 is a schematic diagram illustrating an arrangement of pixels and switching devices in the LCD device according to the third embodiment of the present invention, and FIG. 9 illustrates the arrangement of pixels and a TFT substrate of the LCD device according to the third embodiment of the present invention.

As shown in FIGS. 8 and 9, the structure of the LCD device according to the third embodiment of the present invention is the same as that of the LCD device according to the first or second embodiment of the present invention, except for the arrangement of the pixels, and the LCD device according to the third embodiment of the present invention can be driven by the same driving method as the LCD device according to the first embodiment of the present invention.

In the LCD device according to the third embodiment of the present invention, red pixels R, blue pixels B, and green pixels G are arranged in a matrix pattern. In the present embodiment, a red pixel R, a blue pixel B, and a green pixel G are sequentially arranged on a first row, and a green pixel G, a blue pixel B, and a red pixel R are sequentially arranged on a second row. The pixels of the same color face each other diagonally from opposite sides of the two blue pixels B, over two adjacent pixel rows. The two blue pixels B of adjacent pixel rows and the pixels adjacent to each blue pixel B in each pixel row are referred to as a pixel group a. The pixel group a is repeatedly formed in a row direction and a column direction to form pixel group rows PGR and pixel group columns PGC.

In a TFT substrate of the LCD device according to the third embodiment of the present invention, TFTs T formed in the pixels included in the rows i and i+1 are connected to data lines at the left side of each pixel, and TFTs T formed in the pixels included in the rows i+2 and i+3 are connected to the data lines at the right side of each pixel, as shown in FIG. 8. In other words, the locations of the TFTs T are alternately shifted by pixel group row PGR.

Therefore, the LCD device according to the third embodiment of the present invention can be driven by the same method of driving as the LCD device according to the first embodiment of the present invention and has substantially the same effects as those of the LCD device according to the first embodiment of the present invention.

An LCD device and a driving method thereof according to a fourth embodiment of the present invention will now be described.

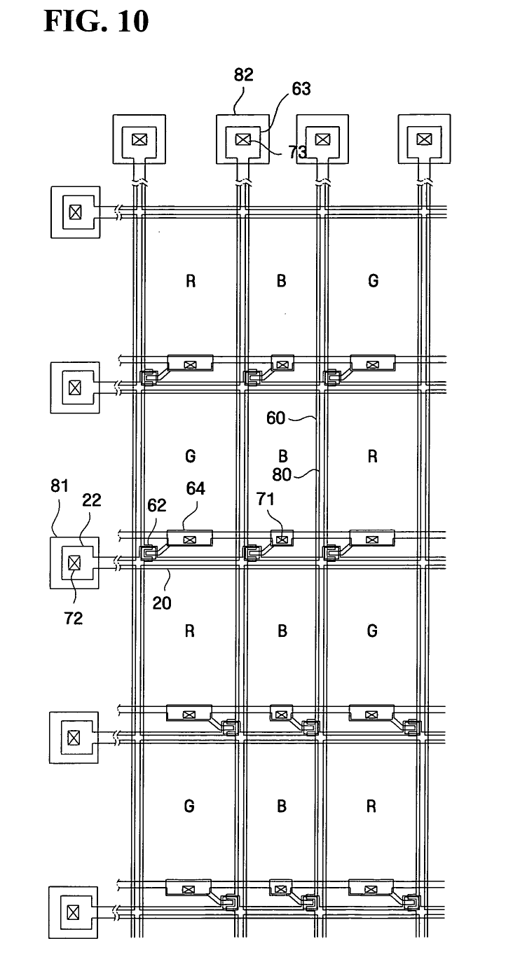

FIG. 10 illustrates an arrangement of pixels and a TFT substrate of an LCD device according to the fourth embodiment of the present invention.

Referring to FIG. 10, a structure of the LCD device according to the fourth embodiment of the present invention is the same as that of the LCD device according to the third embodiment of the present invention, except for the area of the blue pixels B.

When performing a rendering operation, pixel voltages applied to red pixels R and green pixels G are typically established while ignoring the area of blue pixels B, because the blue pixels B do not largely affect resolution. However, the area occupied by the blue pixels B exists, causing a phase error due to a deviation of the center of the pixels of displaying images from the center of the pixels of the rendering operation. To prevent the phase error, the area of the blue pixels B is smaller than the areas of the red pixels R and the green pixels G as shown in FIG. 10.

Therefore, the LCD device according to the fourth embodiment of the present invention can be driven by the same method of driving as the LCD device according to the first embodiment of the present invention and has substantially the same effects as those of the LCD device according to the first embodiment of the present invention while solving problems associated with the phase error.

The LCD device according to the present invention has one or more advantages and effects that follow. First, the LCD device according to the present invention can be operated by the rendering operation method, and can perform the two-dot inversion giving excellent displaying characteristics by regularly inverting the green, blue, and red pixels by frame. Additionally, the white pixels are added to improve the luminance of the LCD device when performing the rendering operation for displaying images at a high resolution. Furthermore, the LCD device according to the present invention can minimize the driving constraint by using the vertical inversion driving method while preventing the vertical flicker phenomenon and vertical crosstalk.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An image display device comprising:
a plurality of pixel groups, each pixel group including a first pixel and a second pixel arranged in a same pixel column of two adjacent pixel rows and adjacent pixels disposed at each row side of the first and second pixels to form at least two dots;
a plurality of gate lines arranged for each pixel row in a horizontal direction to transfer a gate voltage to the respective pixels;
a plurality of data lines arranged for each pixel column in a vertical direction while traversing the gate lines to transfer a data voltage to the respective pixels; and
a switching device formed at each pixel which has a first side and a second side, wherein switching devices formed at pixels of a first pixel group row are connected to the data lines on the first side, and switching devices formed at pixels of a second pixel group row are connected to the data lines on the second side.

2. The image display device of claim 1, further comprising a display panel employing liquid crystal.

3. The image display device of claim 2, wherein the first and second sides of each pixel are opposite to each other with respect to a vertical center line of each pixel.

4. The image display device of claim 2, wherein the first pixel group row and the second pixel group row are next to each other.

5. The image display device of claim 1, wherein the first and second pixels of the pixel group are a blue pixel and a white pixel, respectively, the pixels located at the left side of the blue and white pixels are red and green pixels, respectively, the pixels located at the right side of the blue and white pixels are green and red pixels, respectively, and the pixels of a same color face each other diagonally from opposite sides of the first and second pixels.

6. The image display device of claim 5, wherein the blue and white pixels of one pixel group have a first polarity, the red and green pixels have a second polarity, and the first and second polarities are inverted in each corresponding pixel of pixel groups that are adjacent to each other.

7. The image display device of claim 5, wherein polarities of the pixels are inverted such that neighboring pixels in a same row have opposite polarities, respectively.

8. The image display device of claim 7, wherein polarities of the pixels are inverted such that a pixel of the first pixel group row has a polarity opposite to a polarity of a corresponding pixel of the second pixel group row.

9. The image display device of claim 5, wherein the locations of the blue pixel and the white pixel are alternately shifted between adjacent rows in pixel groups that are adjacent to each other in a row direction.

10. The image display device of claim 1, wherein the first and second pixels of the pixel group are blue pixels, pixels located at the left side of the first and second pixels are red and green pixels, respectively, pixels located at the right side of the first and second pixels are green and red pixels, respectively, and pixels of a same color face each other diagonally from opposite sides of the first and second pixels.

11. The image display device of claim 10, wherein the blue pixels of one pixel group have a first polarity, the red and green pixels of the one pixel group have a second polarity, and the first and second polarities are inverted in each corresponding pixel of pixel groups that are adjacent to each other.

12. The image display device of claim 10, wherein the polarities of the pixels of the first and second pixels have a polarity inverted from the polarity of adjacent pixels of a same row, and the polarities of the pixels of the first pixel group row are inverted from the polarities of corresponding pixels of the second pixel group row.

13. The image display device of claim 10, wherein the blue pixel has an area smaller than an area of each of the green pixel and the red pixel.

14. An image display device comprising:
a plurality of pixel groups formed by sequentially arranging a red pixel, a blue pixel, and a green pixel in one pixel row and sequentially arranging a green pixel, a white pixel, and a red pixel in an adjacent pixel row, wherein the pixels of a same color face each other diagonally from opposite sides of the blue pixel and the white pixel;
a plurality of gate lines formed in a horizontal direction and arranged for each pixel row to transfer a gate voltage to the respective pixels;
a plurality of data lines formed in a vertical direction while traversing the gate lines and arranged for each pixel column to transfer a data voltage to the respective pixels;
a plurality of pixel electrodes formed at each pixel to transfer the data voltage; and
a thin-film transistor (TFT) formed at each pixel which has a first side and a second side, the TFT having a gate electrode connected to a gate line, a source electrode connected to a data line, and a drain electrode connected to a pixel electrode, wherein the source electrode of each TFT formed in a pixel group row is connected to the data line on the first side and the source electrode of each TFT formed in an adjacent pixel group row is connected to the data line on the second side.

15. The image display device of claim 14, wherein the blue and white pixels of one pixel group have a first polarity, the red and green pixels have a second polarity, and the first and second polarities are inverted in each corresponding pixel of pixel groups that are adjacent to each other.

16. An image display device comprising:
a plurality of pixel groups formed by sequentially arranging a red pixel, a blue pixel, a green pixel, a red pixel, a white pixel and a green pixel in one pixel row and sequentially arranging a green pixel, a white pixel, a red pixel, a green pixel, a blue pixel and a red pixel in an adjacent pixel row, wherein the pixels of a same color face each other diagonally from opposite sides of each adjacent blue pixel and white pixel;
a plurality of gate lines formed in a horizontal direction and arranged for each pixel row to transfer a gate voltage to the respective pixels;
a plurality of data lines formed in a vertical direction while traversing the gate lines and arranged for each pixel column to transfer a data voltage to the respective pixels;
a plurality of pixel electrodes formed at each pixel to transfer the data voltage; and
a thin-film transistor (TFT) formed at each pixel which has a first side and a second side, the TFT having a gate electrode connected to a gate line, a source electrode connected to a data line, and a drain electrode connected to a pixel electrode, wherein the source electrode of each TFT formed in a pixel group row is connected to the data line on the first side and the source electrode of each TFT formed in an adjacent pixel group row is connected to the data line on the second side.

17. The image display device of claim 16, wherein the blue and white pixels of one pixel group have a first polarity, the red and green pixels have a second polarity, and the first and second polarities are inverted in each corresponding pixel of pixel groups that are adjacent to each other.

18. An image display device comprising:
a plurality of pixel groups formed by sequentially arranging a red pixel, a blue pixel, and a green pixel in one pixel row and sequentially arranging a green pixel, a blue pixel, and a red pixel in an adjacent pixel row, where the pixels of a same color face each other diagonally from opposite sides of two blue pixels located at the same column in two adjacent pixel rows;
a plurality of gate lines formed in a horizontal direction and arranged for each pixel row to transfer a gate voltage to the respective pixels;
a plurality of data lines formed in a vertical direction while traversing the gate lines and arranged for each pixel column to transfer a data voltage to the respective pixels;
a plurality of pixel electrodes formed at each pixel to transfer the data voltage; and
a thin-film transistor (TFT) formed at each pixel which has a first side and a second side, the TFT having a gate electrode connected to a gate line, a source electrode connected to a data line, and a drain electrode connected to a pixel electrode, wherein the source electrode of each TFT formed in a pixel group row is connected to the data line on the first side and the source electrode of each TFT formed in an adjacent pixel group row is connected to the data line on the second side.

19. The image display device of claim 18, wherein the blue pixels of one pixel group have a first polarity, the red and green pixels have a second polarity, and the first and second polarities are inverted in each corresponding pixel of pixel groups that are adjacent to each other.

20. The image display device of claim 18, wherein each blue pixel has an area smaller than an area of each of the green pixel and the red pixel.

21. A method of driving an image display device having gate lines, data lines, and pixels associated with the gate and data lines, the method comprising:
sequentially providing gate voltages to the gate lines of the image display device;
providing data voltages having a first polarity to the data lines of first and second pixels in a first pixel group; and
providing data voltages having a second polarity to the data lines of pixels surrounding the first and second pixels in the first pixel group.

22. The method of claim 21, further including providing data voltages to the data lines of pixels in a second pixel group, the data voltages provided to the second pixel group each having a polarity inverted from a corresponding data voltage provided to the first pixel group.

23. The method of claim 22, further including:
disposing a first side oriented thin-film transistor on a first side of each pixel of the first pixel group; and
disposing a second side oriented thin-film transistor on a second side of each pixel of the second pixel group, the first side being opposite to the second side, the second pixel group being adjacent to the first pixel group.

24. The method of claim 21, further comprising applying data voltages to the data lines, the data voltages comprising at least one of
a column inversion driving signal; and
a vertical inversion driving signal.
